(19) United States
(12) Patent Application Publication
(10) Pub. No.: US 2008/0140321 A1
(43) Pub. Date: Jun. 12, 2008

(54) Method and a control system for monitoring the condition of an industrial robot

(75) Inventors: Dominique Blanc, Vasteras (SE); Niclas Sjostrand, Vasteras (SE)

Correspondence Address: VENABLE LLP, P.O. BOX 34385, WASHINGTON, DC, 20043-9998, US

(73) Assignee: ABB RESEARCH LTD., Zurich (CH)

(21) Appl. No.: 12/000,254

(22) Filed: Dec. 11, 2007

(30) Foreign Application Priority Data
Dec. 11, 2006 (EP) 06125771.3

(51) Int. Cl. G01L 3/00; G06F 15/00

(52) U.S. Cl. 702/41; 702/183; 901/46

(57) ABSTRACT

A method for monitoring the condition of an industrial robot having a plurality of links movable relative to each other about a plurality of joints. A first value for a first mechanical property for at least one of said joints is calculated based on measured data from the joint. Whether the mechanical property is normal or non-normal is determined based on the calculated mechanical property. The condition of the robot is monitored based on the calculated first value and determination. The first value, determination and monitoring are repeatedly carried out.

### TECHNICAL FIELD

The present invention is concerned with monitoring the performance of an industrial robot. The invention is particularly useful for detecting a malfunction of the robot.

### BACKGROUND ART

An industrial robot comprises a manipulator and a control system. The manipulator comprises links movable relative to each other about a plurality of joints. The links are different robot parts such as a base, arms, and wrist. Each joint has joint components such as a motor, motor gear and motor bearings. The movements of the manipulator are driven by the motors. The control system comprises one or more computers and drive units for controlling the manipulator. The speeds and accelerations of the links are controlled by the control system of the robot that generates control signals to the motors.

Industrial robots are used in industrial and commercial applications to perform precise and repetitive movements. It is then important for a faultless functionality of the robot that the industrial robot is performing according to its nominal performance, which means that the links and joints have to be in good condition and perform together in an expected way.

However it is difficult to detect or determine if an industrial robot is not performing according to its nominal performance. The operator, such as a service technician, has to rely on what he sees and to information from the control system about the performance of the robot such as the position and speed of the motors taken from readings on sensors on the manipulator. The operator then analyses the current condition of the robot based on his personal experience resulting in a varying diagnosis due to subjective measures. In many cases the operator analysing the current condition and performance of the robot also needs to evaluate information from different sources, such as different motors at the same time or external conditions in the facility where the robot is located or is even faced with an emergency stop. To find the cause of a failure the operator may have to try different hypotheses and it is therefore time-consuming and often results in long stand-still periods for the robot causing huge costs.

Also due to frequent personal rotation today, operators of robot service technician staff do not have sufficient experience to diagnose and isolate a failure in the performance of the robot.

Further, if a failure in performance causing an emergency stop to occur, it is difficult to isolate the problem cause and what link or part of the robot that needs special attention.

It is thus desirable to attain a simple method to monitor the current performance or condition of the robot.

### SUMMARY OF THE INVENTION

The aim of the invention is to provide a method to monitor malfunction of an industrial robot.

Such a method for monitoring malfunction of an industrial robot having a plurality of links movable relative to each other about a plurality of joints comprises:
calculating a first value for a first mechanical property for at least one of the joints based on measured data from the joint,
determining whether the mechanical property is normal or non-normal based on the calculated mechanical property, and based thereon monitoring the condition of the robot.

This makes it possible to monitor the current performance or condition of the robot. By monitoring the condition it is made possible to detect malfunction of the robot. When the condition of the performance of the robot changes due to wear and/or breakdowns of the manipulator, the measured data will show these changes. Also if the value is changing over time it is possible to detect that the condition of the robot is changing. Also if the performance is not normal it makes it possible to isolate the problem cause and what link or part of the robot that needs special attention.

According to an embodiment of the invention, first mechanical property value is a play value or a mechanical noise value. The first mechanical property value can also be a friction value. These values indicate malfunction of the robot if they deviate from normal values. If a malfunction occurs in the manipulator, the values of these mechanical properties are changing. An increase in friction, for example, depends on wear of the bearings of the robot or bad oil. An increase in play may depend on wear of the bearing that results in a play between the teeth of the bearing. This type of wear of the bearing may lead to a decrease of the friction value. From the noise value it is, for example, possible to detect defects in the sensors measuring the angular position of the joints of the robot.

A first condition parameter is calculated, which indicates whether the first mechanical property is normal or non-normal, based on the calculated first mechanical property, and the condition of the robot is monitored based on the first condition parameter. Preferably, the condition parameter is repeatedly calculated during operation of the robot. The condition parameter is a measure of the degree of deviation from normal conditions of the mechanical property. The condition parameter is, for example, displayed to the robot operator. This enables the operator to notice a change in the parameter, which indicates that the mechanical property is changing from normal to non-normal, and also enables the operator to notice the rate of change of the parameter. This embodiment makes it possible for the operator to take necessary actions, such as initiate service of the robot, before the performance of the robot is strongly reduced or damages of the robot occurs. This helps the operator to decide at which point in time the action has to be taken. Further, depending on the value of the condition parameter it is possible to detect the degree of deviation from non-normal of the mechanical property.

The measured data may include information on the motor torque and/or the angular position of at least one motor driving at least one link. This is an advantage because this information is already measured for other purposes such as path planning.

In another embodiment of the invention the method further comprises calculating a second value for a second mechanical property, determining whether the second mechanical property is normal or non-normal based on the calculated second mechanical property, and monitoring the condition of the robot based thereon. Preferably, a second condition parameter is calculated, which indicates whether the second mechanical property is normal or non-normal based on the calculated second mechanical property, and monitoring the condition of the robot based on the first and second condition parameters. Monitoring two mechanical properties increases the possibility to detect a malfunction of the robot. Preferably the second mechanical property is any of play, noise, and friction. This embodiment further makes it possible to calculate two mechanical properties based on one measurement of the motor torque and/or the motor angular position. By monitoring two mechanical properties, for example both friction and play, it is possible to detect more types of faults. For example, wear of the bearing that results in a play between the teeth of the bearing cannot be detected if only friction values are monitored.

In another embodiment of the invention, the method further comprises calculating a third value for a third mechanical property, determining whether the third mechanical property is normal or non-normal based on the calculated third mechanical property, and monitoring the condition of the robot based thereon. Preferably, the method further comprises calculating a third condition parameter, which indicates whether the third value is normal or non-normal based on the calculated third value, and monitoring the condition of the robot based on the first, second, and third condition parameters. Monitoring three different mechanical properties increases the possibility to detect malfunction of the robot. Preferably the mechanical properties are play, noise, and friction. This combination of mechanical properties are advantageous since they together make it possible to detect many different types of malfunction of the robot. This embodiment further makes it possible to calculate three mechanical properties based on one measurement of the motor torque or the motor angular position.

In another embodiment of the invention, the method further comprises deciding when there is a malfunction based on the condition parameters. In a more preferred embodiment of the invention, the method further comprises generating an alarm if any of the condition parameters indicates that the mechanical property is non-normal. This is an advantage when the method is used for automated supervison. In a preferred embodiment this is used to generate an emergency stop if a malfunction has occurred.

In another embodiment of the invention the method further comprises:
calculating a deviation between the calculated mechanical property value and an expected mechanical property value, and
calculating the condition parameter based on the deviation.

This makes it possible to detect the degree of malfunction of the robot depending on the value of the deviation within a range.

In another embodiment of the invention the calculated friction value is a function of at least two of the following friction values: the viscous friction, the Coulomb friction, the static friction, the Stribeck friction. By calculating more friction values a more accurate friction value is obtained.

In another embodiment of the invention at least the calculated friction value is a function of the viscous friction and the Coulomb friction. This is an advantage because these friction values have the largest contribution to the friction and therefore gives a calculated approximate value with sufficient accuracy.

In another embodiment of the invention the method further comprises:
moving one of the links in the direction of gravity,
moving the one link in a direction opposite the gravity direction,
collecting measured data during the movements of the link,
keeping the velocity essentially constant while collecting the measured data, and
calculating the at least one friction value based on the collected measured data.

This is an advantage because it simplifies the calculations when monitoring the current performance or condition of the robot because this makes it possible to eliminate the terms due to gravity.

In another embodiment of the invention at least one friction value is the viscous friction.

In another embodiment of the invention the calculated friction value is the motor torque due to friction.

Such a control system for monitoring the condition of an industrial robot having a plurality of links movable relative to each other about a plurality of joints, comprises: a calculating unit adapted to calculate a first value for a first mechanical property for at least one of the joints based on measured data from the joint, and to determine whether the first mechanical property is normal or non-normal based on the calculated first mechanical property, and a monitoring unit for monitoring the condition of the robot based on the determination of whether the first mechanical property is normal or non-normal.

The invention also concerns a computer program directly loadable into the internal memory of a computer.

The invention also concerns a computer-readable medium having a computer program recorded thereon.

The invention also relates to a computer program as well as a computer-readable medium according to the corresponding appended claims. The steps of the method according to the invention are well suited to be controlled by a processor provided with such a computer program.

Other advantageous features of the invention will appear from the following description.

### BRIEF DESCRIPTION OF THE DRAWINGS

The present invention will be described in more detail in connection with the enclosed schematic drawings.

FIG. 1A shows an industrial robot comprising a manipulator and a control system adapted to control the robot,

FIG. 1B shows two links movable relative to each other about a joint,

FIG. 2 shows a block diagram of a part of a control system for monitoring malfunction of an industrial robot,

FIG. 3A shows a block diagram illustrating a method for monitoring malfunction of an industrial robot according to a first embodiment of the invention,

FIG. 3B shows a block diagram illustrating a method for monitoring malfunction of an industrial robot according to a second embodiment of the invention,

FIG. 3C shows a block diagram illustrating a method for monitoring malfunction of an industrial robot according to a third embodiment of the invention,

FIG. 4 shows a diagram illustrating another method for monitoring malfunction of an industrial robot comprising a friction model,

FIG. 5 shows a diagram illustrating another method for monitoring malfunction of an industrial robot comprising a backlash model, and

FIG. 6 shows a noise diagram illustrating another method for monitoring malfunction of an industrial robot comprising a noise model.

### DESCRIPTION OF THE PREFERRED EMBODIMENTS

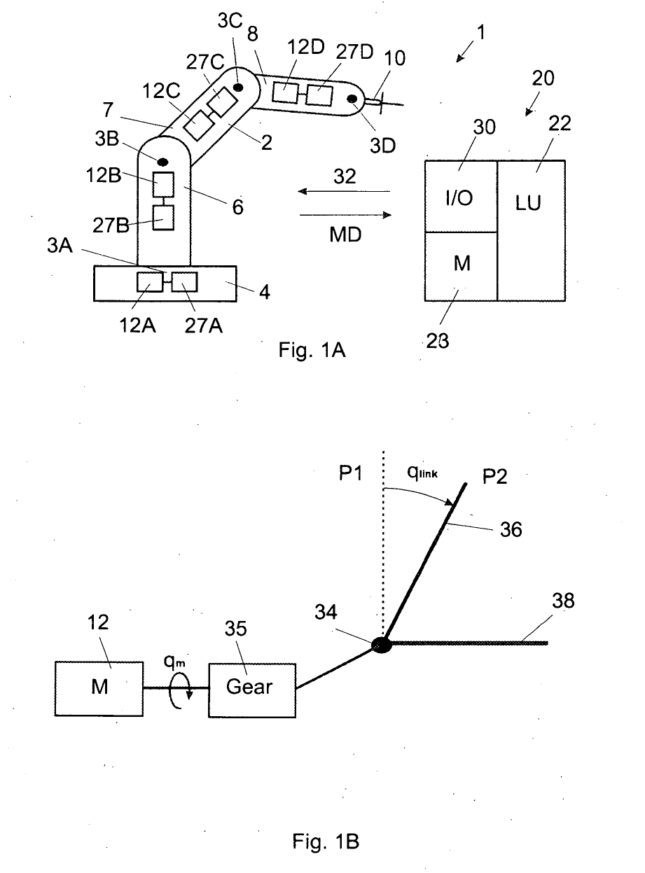

FIG. 1A shows an industrial robot 1 comprising a manipulator 2 and a control system. The industrial robot has a plurality of links movable relative to each other about a plurality of joints 3A,3B,3C,3D, in this case rotatable in relation to each other around an axis of rotation. The links are in this case robot parts, such as a stand 4, robot arms 6,7,8, and a wrist 10 comprising a turn disc. The industrial robot comprises a plurality of motors 12A,12B,12C,12D controlling the position and speed of the links. The control system is illustrated as a simplified block diagram. The control system comprises, in this case, a control unit 20 including one or more logic units 22, a memory unit 23 and drive units 27A,27B,27C,27D for controlling the motors. The logic unit comprises a microprocessor, or processors comprising a central processing unit (CPU) or a field-programmable gate array (FPGA) or any semiconductor device containing programmable logic components. The control unit is adapted to run a control program, stored in the memory unit 23. The control unit is further adapted to generate a movement path based on movement instructions in the control program run by the logic units 22.

The drive units 27A,27B,27C,27D are controlling the motors by controlling the motor current and the motor position in response to control signals from the control unit 20. The control unit 20 comprises input/output interfaces (I/O) 30. On the robot and in the environment surrounding the robot there are also arranged a plurality of sensors. The sensors on the manipulator 2 and in the environment of the manipulator 2 are connected to the I/O 30 of the control unit 20 via a wired or wireless link 32. The control unit 20 thereby receives signals comprising measured data MD. The measured data MD may, for example, be robot condition monitoring data or log information from the robot controller. The measured data MD comprises, for instance, motor angular position, motor speed, tilting, load and environmental data such as the temperature. The industrial robot has rotational axes, linear axes or a mixture of both.

A model of the joints is established. FIG. 1B illustrates such an embodiment of a model of a joint 34, wherein the model comprises, in this case, two links: a first link 36 and a second link 38 movable relative to each other about the joint 34. The model is a static rigid two-mass model without flexibilities, and the assumption is used that only one link is moved at the time.

In the model, the first link 36 is considered moving relative to the second link 38. The second link 38 is considered relatively motionless in the model. The movement of the first link 36 is driven and controlled by a motor 12 connected to the joint via a gear 35. In the figure a movement of the first the link 36 from a first position P1 to a second position P2 is illustrated, which corresponds to an angular position qₗᵢₙₖ. To record the movement of the link, it is necessary to transform the data from an angular position of the motor qₘ to the angular position qₗᵢₙₖ of the link. The transmission from the motor to the link is characterized by a gear ratio n. We therefore use the assumption that n times the angular position qₗᵢₙₖ of the first link relative to the second link is considered corresponding to an angular position qₘ of the motor.

qₘ=n*qₗᵢₙₖ (1)

In the embodiments described below the measured data for the joint 34 in this case comprises information on the angular position qₘ, and the torque Tₘ of the motor. The velocity qₘ′ and the acceleration qₘ″ of the motor are, for instance, derived from the angular position qₘ using a mathematical method such as central difference calculations:

Velocity=v=qₘ′ (2)

Acceleration=A=v′=qₘ″ (3)

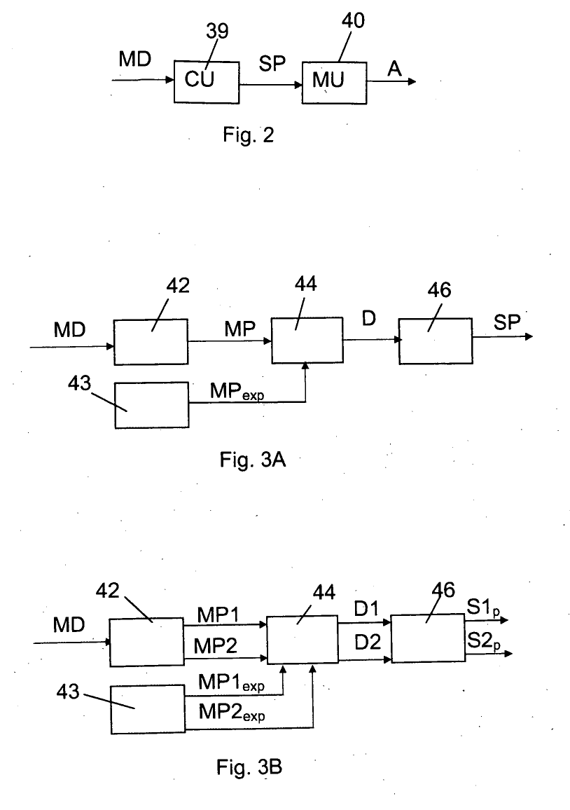

FIG. 2 shows a part of the control system for monitoring malfunction of an industrial robot, such as the industrial robot 1 described above. The control system comprises a calculating unit 39 and a monitoring unit 40. It is to be understood that the control system comprises these units either as hardware or software units.

The calculating unit 39 is adapted to calculate a value for a mechanical property MP, for at least one of the joints based on measured data MD from the joint. The mechanical property value is any of: a friction value, a play value, a mechanical noise, and a vibration value of the joint. The calculating unit 39 is further adapted to calculate a condition parameter SP, which indicates whether the mechanical property is normal or non-normal, based on the calculated mechanical property MP. The monitoring unit 40 is adapted to monitor the condition of the robot based on the condition parameter SP.

FIG. 2 also describes a method for monitoring malfunction of an industrial robot. First a joint is selected. A plurality of measured data MD for the selected joint are collected. A value for the mechanical property MP for the joint is calculated based on measured data MD from the joint. Then the condition of the robot is monitored based on the calculated mechanical property MP.

In one embodiment of the invention, a condition parameter SP, which indicates whether the mechanical property is normal or non-normal, is calculated based on the calculated mechanical property MP. Then the condition of the robot is monitored based on the condition parameter SP.

In another embodiment of the method a decision is made in the monitoring unit 40 whether or not there is a malfunction based on the condition parameter SP.

In another embodiment of the method, an alarm A is generated if the condition parameter SP indicates that the mechanical property is non-normal.

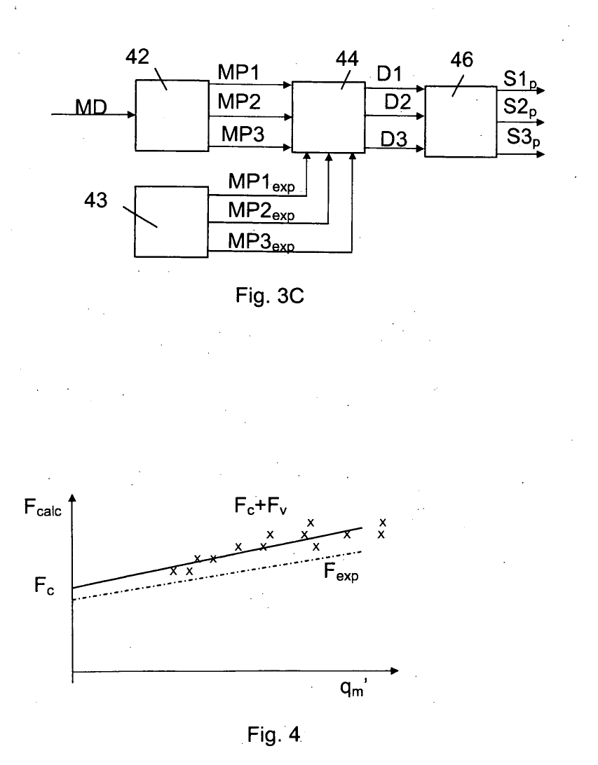

FIG. 3A shows a first embodiment of the method for monitoring malfunction of an industrial robot and is also describing an embodiment of the calculating unit 39 more in detail. The mechanical property value MP is calculated for the selected joint based on the measured data MD from the joint in a mechanical property calculating unit 42. An expected mechanical property MPₑₓₚ is retrieved, for instance, from the memory of the control unit or calculated based on prestored data in a retrieving unit 43. Then the calculated mechanical property MP is compared with the expected mechanical property MPₑₓₚ in a comparing unit 44, wherein a deviation D between the calculated mechanical property MP and the expected mechanical property MPₑₓₚ is calculated. After that a condition parameter SP is calculated based on said deviation D in a condition calculating unit 46. The condition parameter is, for example, calculated as a quotient between the deviation and the expected mechanical property: SP=D/MPₑₓₚ. If the difference between the calculated and expected mechanical property values is small or zero, the condition parameter will become zero, or close to zero, which indicates that the first mechanical property MP is normal. If the value of the condition parameter is increasing and/or becomes above a threshold value, it is an indication of the fact that the first mechanical property MP is non-normal or is close to being non-normal. Alternatively, the condition parameter can be calculated by using a logarithm of the difference D or a derivative of the mechanical property value.

In another embodiment of the inventive method, the expected mechanical property value MPₑₓₚ is calculated using a reference movement set up for the robot. The resulting estimated expected mechanical property value MPₑₓₚ is stored, for instance, in the memory 23 of the control system as initial values of the expected mechanical property values.

In another embodiment of the invention, the expected mechanical property value MPₑₓₚ is calculated continuously during operation of the robot. The expected mechanical property value MPₑₓₚ is then MPₑₓₚ₁, MPₑₓₚ₂, . . . MPₑₓₚₙ

FIG. 3B shows a second embodiment of the invention and is also describing another embodiment of the calculating unit 39 more in detail. A first mechanical property value MP1 is calculated as described above. This embodiment of the method further comprises calculating a second value for a second mechanical property MP2.

The mechanical property values MP1 and MP2 are calculated in the mechanical property calculating unit 42. A first expected mechanical property MP1ₑₓₚ and a second expected mechanical property MP2ₑₓₚ are retrieved for each mechanical property from the retrieving unit 43. Then the calculated mechanical property values MP1 and MP2 are compared with the respective expected mechanical property MP1ₑₓₚ and MP2ₑₓₚ in the comparing unit 44. A first deviation D1 between the first calculated mechanical property MP1 and the expected first mechanical property MP1ₑₓₚ is calculated. A second deviation D2 between the second calculated mechanical property MP2 and the expected second mechanical property MP2ₑₓₚ is calculated. After that a first condition parameter S1ₚ is calculated based on the first deviation D1 and a second condition parameter S2ₚ is calculated based on the second deviation D12 in the condition calculating unit 46. The condition parameters S1ₚ and S2ₚ indicate whether the first and second mechanical properties are normal or non-normal.

In another embodiment of the invention, one condition parameter SP is calculated based on both the mechanical properties wherein the condition parameter SP indicates whether the first and second mechanical properties are normal or non-normal. The condition of the robot may then be monitored based on the single mechanical property SP or based on the first S1ₚ and second condition parameters S2ₚ. The first and the second mechanical property values MP1, MP2 are any combination of a friction value, a play value, a mechanical noise and a vibration value of the joint.

FIG. 3C shows a third embodiment of the invention and is also describing yet another embodiment of the calculating unit 39 more in detail. A first mechanical property value MP1 is calculated based on a first mechanical property value, a second mechanical property value MP2 is calculated based on a second mechanical property value, as described above. The third embodiment of the invention further comprises calculating a third mechanical property value MP3 based on a third mechanical property value. The condition of the robot is then monitored based on the first, second, and third mechanical property values MP1, MP2, MP3. The first, the second and the third mechanical property values MP1, MP2, MP3 are any combination of a friction value, a play value, a mechanical noise and a vibration value of the joint.

The mechanical property values MP1, MP2, MP3 are calculated in the mechanical property calculating unit 42. A first expected mechanical property MP1ₑₓₚ, a second expected mechanical property MP2ₑₓₚ and a third expected mechanical property MP3^{exp} are retrieved for each mechanical property from the retrieving unit 43. Then the calculated mechanical property values MP1, MP2 and MP3 are compared with the respective expected mechanical property MP1ₑₓₚ, MP2ₑₓₚ and MP3ₑₓₚ in the comparing unit 44. A first and a second deviation D1 and D2 are calculated as described above in the second main embodiment. Further a third deviation D3 between the third calculated mechanical property MP3 and the expected third mechanical property MP3ₑₓₚ is calculated. After that a first, a second and a third condition parameter S1ₚ, S2ₚ, and S2ₚ are calculated based on the first deviation D1, the second deviation D2 and the third deviation D3, respectively. The condition parameters S1ₚ, S2ₚ and S3ₚ indicate whether the first, second and third mechanical properties are normal or non-normal. The condition of the robot is then monitored based on the first, second, and third condition parameters S1ₚ,S2ₚ,S3ₚ.

FIG. 4A shows a diagram illustrating a fourth main embodiment of the method described above wherein the mechanical property value MP is a friction value. The fourth main embodiment of the method further comprises a friction model for an industrial robot joint, illustrated in the diagram. In the friction model the calculated mechanical property value MP is a calculated friction value F_{calc} that is considered to be a sum term of all friction forces. The sum term F_{calc} of all friction forces is calculated based on measured data MD from the selected joint. In the diagram the representation of the measured data is displayed as crosses. The friction forces are considered due to the movement of the motors and gears of the selected joint. Friction is, in this embodiment, considered a function of the relative speed of the links in contact with each other during movement of the links relative to each other about the joints. In this embodiment of the method a comparison between the calculated friction value F_{calc} and at least one expected friction value Fₑₓₚ for a selected joint, wherein a deviation D between the calculated friction value F_{calc} and the expected friction value Fₑₓₚ is calculated. After that it is determined whether the friction is normal or non-normal based on the calculated deviation D. The continuous line in the diagram represents an adaption to the measured data. The formula determining the adapted continuous line then determines the calculated friction value F_{calc}. The adaptation is done using a mathematical numerical equation evaluation method, for instance a regression analysis. The dotted line represents the value of the expected friction Fₑₓₚ. The deviation D is then the difference between the calculated friction value F_{calc} and the expected friction Fₑₓₚ. The deviation D is then calculated by analyzing the diagram using a mathematical numerical equation evaluation method, for instance the least-squares method.

In this first main embodiment we further make the assumption that the calculated friction value F_{calc} is a function of the Coulomb friction F_{c} and the viscous friction Fᵥ. The Coulomb friction F_{c} is the friction that has to be overcome to start the movement between the links. The viscous friction Fᵥ is the friction that has to be overcome to continue the movement between the links. In this model we estimate that the sum term of all friction forces, the calculated friction value F_{calc} is the sum of the following two factors, the viscous friction Fᵥ multiplied by the velocity v of the first link relative the second link and the Coulomb friction F_{c} multiplied by the signum function:

F_{calc}=Fᵥ*v+F_{c}*sign(v) (4)

In another embodiment of the fourth main embodiment of the method to monitor malfunction of an industrial robot the assumption that only one link is moving is made. The method comprises:
moving one of said links in the direction of gravity,
moving said one link in a direction opposite to the gravity direction,
collecting measured data during the movements of the link,
keeping the velocity essentially constant while collecting the measured data, and
calculating said at least one friction value based on the collected measured data.

The collecting of measured data is thereby construed so that the components dependent on gravity cancel each other. This will give a simpler calculation.

To solve the difference between the measured motor torque T_{mforward} in a first direction and the measured motor torque T_{mfback} in the opposite direction the following equation may be used:

T_{fric}=[T_{mforward}−T_{mback}(q′ₘ, q)]/2 (5)

When moving only one link so that components dependent on gravity cancel each other, i.e. rotation of a link where the link moves back and fourth along the direction of gravity, the gravitation terms of the equation will have the same quantity but different signs so that they eliminate each other. Because the gravitation terms of the equation eliminate each other they do not need to be determined in the calculations.

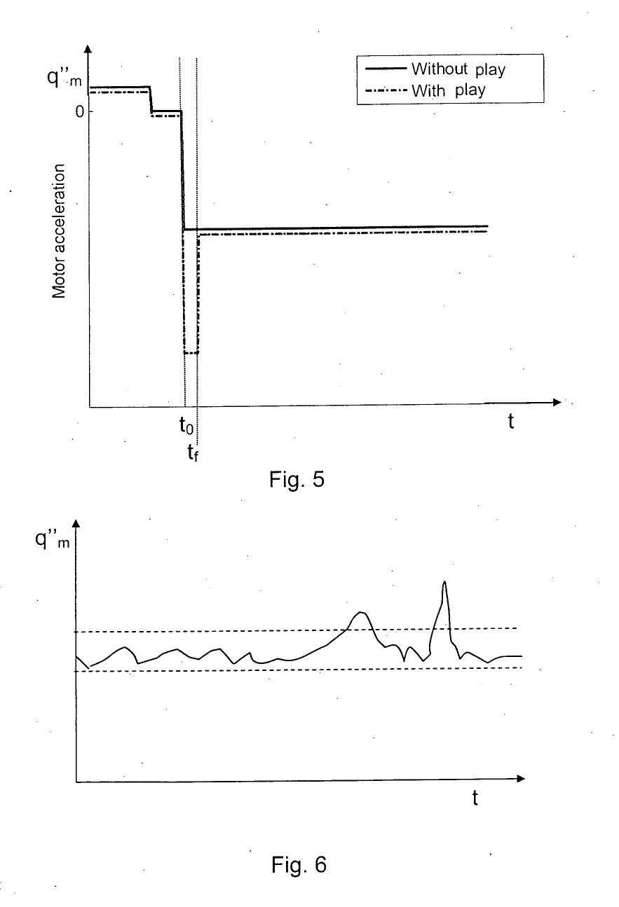

FIG. 5 shows a diagram illustrating how play affects the motor acceleration versus time for a joint of the robot. Play occurs in the motor movement of a motor driving a link when two mechanical parts in the motor, such as in a gear box or in motor bearings, are not in physical contact with each other and thus cause the motor to move without driving the link. The lost motion may occur when a motor is run in forward and reverse directions. The figure shows the motor acceleration q″ₘ depending on time t. The time to is the time when the lost motion starts and t_{f} the time when the lost motion ends, respectively. The play is detected in that the acceleration suddenly drops at to and suddenly increases rapidly at t_{f}.

The play can also be detected by monitoring the oscillation (frequency analysis) caused by the non-linear dynamics of the play.

According to an embodiment of the invention, the condition of an industrial robot is monitored by continuously monitoring the play of the joints of the robot. Thus, the first mechanical property value MP is a play value. The play value P is in this case a quantity that represents when two mechanical parts are not in contact with each other due to unpredicted clearance between the mechanical parts. The play value ω is calculated by either taking the integral of the velocity during the lost motion time period or the absolute position difference between the start of lost motion and end of lost motion.

$$ϕ = {\int }_{{t}_{0}}^{{t}_{f}} {q}_{m}^{′} ( t ) d t = \vert {q}_{m} ( {t}_{f} ) - {q}_{m} ( {t}_{o} ) \vert \qquad ( 7 )$$

The monitoring of the condition of the industrial robot is, for example, done by monitoring variations in play, also denoted backlash. In one embodiment of the invention, the malfunction of an industrial robot is monitored by repeatedly: calculating a first mechanical property value MP, representing a play value, for at least one of the joints based on measured data MD from the joint, and calculating a condition parameter SP, which indicates whether the play value is normal or non-normal, based on the calculated mechanical property, monitoring the condition of the robot based on the condition parameter SP.

The determination of whether the mechanical property is normal or not is, for instance, done by comparing the play value with a maximally allowed play value, or with a nominal play value specific for the manipulator in use. Alternatively, the determination whether the mechanical property is normal or not is done by detecting a continuous variation in play over time, such as a continuous increase in play, i.e. following a trend.

For example, a curve representing the play value dependent on time is displayed on an external display. The calculated play value may also be compared with a predetermined maximum play value or a calibrated value. The difference between the calculated play value and a maximum play value may also be calculated and monitored on an external display for the use of the operator. The condition parameter SP may also be shown on an external display. The calculated play value MP, the condition parameter SP or the comparison between the calculated play value and a maximum play value, such as a difference, may also be handled internally in the control system, for instance for initiating the creation of an alarm.

FIG. 6 illustrates noise in the motor acceleration of the robot joint. According to an embodiment of the invention, the mechanical property value MP is a mechanical noise value. A noise value is in this case considered a signal with abnormal amplitude and/or abnormal frequency, such as ripple, when the position value q is measured. In one embodiment of the method wherein the mechanical property is a noise value, linear mechanical noise is monitored. The noise value is, for instance, calculated by calculating a root mean square value (RMS) of the noise value over time, or by calculating the peak-to-peak value of the noise values The diagram shows the motor acceleration q″ₘ depending on time t. The diagram shows the variations in a continuous motor acceleration due to mechanical noise. An upper and a lower limit in variation are also shown in the diagram. The noise value can also be calculated by using the measured data on the motor torque Tₘ or the angular position qₘ of the motor driving a link, or the speed of the motor q′ₘ.

Detecting whether the noise value is normal or not is done, for instance, by comparing the noise value with a maximum noise value or a nominal noise value specific for the manipulator in use. In another embodiment detecting whether the noise value is normal or not is done by detecting a continuous variation in noise over time, such as a continuous increase in mechanical noise, i.e. following a trend.

This invention is applicable to all industrial areas where industrial robots are mandated and other areas where introducing industrial robots is under discussion. It will be understood by those skilled in the art that various modifications and changes may be made to the present invention without departure from the scope thereof, which is defined by the appended claims. In the above mentioned embodiments of the methods the sum term F_{calc} of all friction forces, for instance Fᵥ and F_{c}, may be calculated for different links and for different loads.

In a physical implementation of the invention, for instance, the operator uses: a tablet personal computer PC, a wearable computer, manipulators, hand-held control devices, and, for instance, with wireless access to information via General Packet Radio Service (GPRS), WLAN, Bluetooth or other.

The first mechanical property can also be a vibration value, for example a measure of the vibrations in the actuators of the robot.

1. A method for monitoring a condition of an industrial robot comprising a plurality of links movable relative to each other about a plurality of joints, the method comprising repeatedly:
calculating a first value for a first mechanical property for at least one of said joints based on measured data from said joint, and
determining whether the mechanical property is normal or non-normal based on the calculated mechanical property, and based thereon monitoring the condition of the robot.

2. The method according to claim 1, wherein said first mechanical property value is a play value or a mechanical noise value.

3. The method according to claim 1, further comprising:
calculating a second value for a second mechanical property, determining whether the second mechanical property is normal or non-normal based on the calculated second mechanical property, and
monitoring the condition of the robot based thereon.

4. The method according to claim 3, wherein said second mechanical property value is any of a friction value, a play value, or a noise value.

5. The method according to claim 4, further comprising:
calculating a third value for a third mechanical property,
determining whether the third mechanical property is normal or non-normal based on the calculated third mechanical property, and
monitoring the condition of the robot based thereon.

6. The method according to claim 5, wherein said first mechanical property is a noise value, said second mechanical property is a friction value, and said third mechanical property is a play value.

7. The method according to claim 1, wherein said measured data includes information on the motor torque or the angular position of at least one motor driving at least one link, or information on the motor torque and the angular position of at least one motor driving at least one link.

8. The method according to claim 1, wherein said first mechanical property value is a friction value.

9. The method according to claim 8, wherein the calculated friction value includes at least two of the following friction values: the viscous friction the Coulomb friction the static friction, and the Stribeck friction.

10. The method according to claim 8, further comprising:
moving one of said links in the direction of gravity,
moving said one link in a direction opposite the gravity direction,
collecting measured data during the movements of the link,
keeping the velocity essentially constant while collecting the measured data, and
calculating said at least one friction value based on the collected measured data.

11. The method according to claim 10, wherein the calculated friction value is the motor torque due to friction.

12. A control system for monitoring the condition of an industrial robot comprising a plurality of links movable relative to each other about a plurality of joints, the control system comprising:
a calculating unit adapted to calculate a first value for a first mechanical property for at least one of said joints based on measured data from said joint, and to determine whether the first mechanical property is normal or non-normal based on the calculated first mechanical property, and
a monitoring unit for monitoring the condition of the robot based on said determination of whether the first mechanical property is normal or non-normal.

13. The control system according to claim 12, wherein said first mechanical property value is a play value or a mechanical noise value.

14. The control system according to claim 12, wherein said calculating unit further is adapted to calculate a second value for a second mechanical property and said monitoring unit is adapted to monitor the condition of the robot based on said determination of whether the second mechanical property is normal or non-normal.

15. The control system according to claim 12, wherein said second mechanical property value is a friction value.

16. The control system according to claim 14, wherein said calculating unit further is adapted to calculate a third value for a third mechanical property and said monitoring unit is adapted to monitor the condition of the robot based on said determination of whether the third mechanical property is normal or non-normal.

17. The control system according to claim 16, wherein said first mechanical property is a noise value, said second mechanical property is a friction value, and said third mechanical property is a play value.

18. A computer program product, comprising:
a computer readable medium; and
computer program instructions recorded on the computer readable medium and executable by a processor for carrying out a method for monitoring a condition of an industrial robot comprising a plurality of links movable relative to each other about a plurality of joints, the method comprising repeatedly calculating a first value for a first mechanical property for at least one of said joints based on measured data from said joint, and determining whether the mechanical property is normal or non-normal based on the calculated mechanical property, and based thereon monitoring the condition of the robot.

19. (canceled)
